(19) United States
(12) Patent Application Publication
(10) Pub. No.: US 2010/0018009 A1
(43) Pub. Date: Jan. 28, 2010

(54) Clips for Aligning Optical Components in a Solar Concentrating Array

(75) Inventor: Marc Finot, Palo Alto, CA (US)

Correspondence Address: THE MUELLER LAW OFFICE, P.C., 12951 Harwick Lane, San Diego, CA, 92130, US

(73) Assignee: SOLFOCUS, INC., Mountain View, CA (US)

(21) Appl. No.: 12/177,874

(22) Filed: Jul. 22, 2008

(51) Int. Cl. A44B 21/00; B23P 15/26

(52) U.S. Cl. 24/455; 29/890.033

(57) ABSTRACT

Manufacturing of solar concentrators require the placement of primary optical components, a parabolic mirror for example, on a relatively fiat front panel in a predetermined alignment within a certain tolerance limit. Clips, in accordance with embodiments of the present invention, can be used to facilitate locating, placing and securing the primary optical components on the front panel, thereby enhancing manufacturability of the solar concentrator.

### BACKGROUND OF THE INVENTION

It is generally appreciated that one of the many known technologies for generating electrical power involves the harvesting of solar radiation and its conversion into direct current (DC) electricity. Solar power generation has already proven to be a very effective and “environmentally friendly” energy option, and further advances related to this technology continue to increase the appeal of such power generation systems. In addition to achieving a design that is efficient in both performance and size, it is also desirable to provide power units and corresponding solar systems that are characterized by reduced cost and increased levels of mechanical robustness.

Solar concentrators are solar energy generators which increase the efficiency of conversion of solar energy to DC electricity. Solar concentrators which are known in the art utilize parabolic mirrors and Fresnel lenses for focusing the incoming solar energy, and heliostats for tracking the sun's movements in order to maximize light exposure. A new type of solar concentrator, disclosed in U.S. Patent Publication No. 2006/0266408, entitled, “Concentrator Solar Photovoltaic Array with Compact Tailored Imaging Power Units” utilizes a front panel for allowing solar energy to enter the assembly, with a primary mirror and a secondary mirror to reflect and focus solar energy onto a solar cell. A back panel and housing enclose the assembly and provide structural integrity. The surface area of the solar cell in such a system is much smaller than what is required for non-concentrating systems, for example less than 1% of the entry window surface area. Such a system has a high efficiency in converting solar energy to electricity due to the focused intensity of sunlight, and also reduces cost due to the decreased amount of costly photovoltaic cells required. Because the receiving area of the solar cell is small relative to that of the power unit, the ability of the mirrors to accurately focus the sun's rays onto the solar cell is important to achieving the desired efficiency of such a solar concentrating system.

In this type of solar concentrator, one of the important factors in manufacture is the mechanism and process by which a mirror is aligned and secured in the x-y plane and vertically along the z-axis of the front panel. Commonly assigned U.S. patent application Ser. No. 11/640,052 entitled “Optic Spacing Nubs” addresses securing and aligning mirrors along the vertical z-axis of the front panel. The application, in general, describes a mirror having three or more nubs as an integral part of the mounting surface of the mirror. When the solar concentrator is assembled, these nubs are configured between the panel and the mirror and provide a substantially uniform gap for an adhesive. The mirror is secured to the panel by the adhesive. Thus, the nubs assist with desired attachment and alignment of the mirror to the panel in the solar energy system. This system of manufacture enhances manufacturability with respect to alignment of the mirrors along the z-axis. However, it leaves alignment of the mirrors in the x-y plane to a cumbersome manufacture process. Thus, it is desirable to facilitate reliable alignment of mirrors in a solar concentrator in the x-y plane of a concentrator panel in a manner that facilitates manufacturability and improves mechanical robustness. In addition, the choice of materials for securing the primary mirror to the front panel is limited due to the extended specifications for this joint (the joint should have flexibility and low creep). The joint specifications are usually incompatible with a fast cure material, and thus requiring an adhesive with long curing time. A method and mechanism to fix the primary mirror quickly allowing/permitting movement of the array relatively quickly very desirable in order to increase the production throughput.

### SUMMARY OF THE INVENTION

The present invention is a system for securing and aligning optical components in an array, where the optical components concentrate solar energy. In one embodiment, a securing member is attached to a front panel in a predetermined pattern to achieve a desired alignment of the optical components. The securing members extend upwards from a front panel in a non-securing position, and are deformable into a securing position. In the securing position, the securing members abut against adjacent optical components within the array, which secures the optical components in approximate accordance with the desired alignment of the optical components.

### BRIEF DESCRIPTION OF THE DRAWINGS

FIG. 1 depicts solar concentration panels as known in the prior art;

FIG. 2 depicts a cross-section of a solar concentrating power unit as known in the prior art;

FIG. 3 depicts an embodiment of a primary as known in the prior art;

FIG. 4 depicts another embodiment of a primary as known in the prior art;

FIG. 5 depicts another embodiment of a primary mirror as known in the prior art;

FIG. 6 depicts a schematic of an array of solar concentrating power units in accordance with an embodiment of the present invention;

FIG. 7 depicts a cross-section of a solar panel in accordance with an embodiment of the present invention;

FIGS. 8A-D depict several embodiments of clips used to secure the primary mirrors to the front panel of the solar concentrating panel in accordance with the present invention;

FIGS. 9A-B depict an alternative embodiment of a clip used to secure the primary mirrors to the front panel of the solar concentrating panel in accordance with the present invention;

FIGS. 9C-D depict clip placement on a front panel and additional details; and

FIG. 9E illustrates a method for installing the primary mirrors on the front panel.

### DETAILED DESCRIPTION OF THE EMBODIMENTS

Reference now will be made in detail to embodiments of the disclosed invention, one or more examples of which are illustrated in the accompanying drawings. Each example is provided by way of explanation of the present technology, not a limitation of the present technology. It will be apparent to those skilled in the art that modifications and variations can be made in the present technology without departing from the spirit and scope thereof. For instance, features illustrated or described as part of one embodiment may be used on another embodiment to yield a still further embodiment. Thus, it is intended that the present subject matter covers such modifications and variations as come within the scope of the appended claims and their equivalents.

The alignment processes and mechanisms described in this disclosure are based on a solar power concentrator design incorporating optically aligned primary and secondary mirrors. The solar power concentrator design is described with further detail in U.S. Patent Publication No. 2006/0266408 entitled, “Concentrator Solar Photovoltaic Array with Compact Tailored Imaging Power Units,” filed May 26, 2005, and U.S Patent Publication No. 2006/0274439 entitled, “Optical System Using Tailored Imaging Designs,” filed Feb. 9, 2006, which claims priority from U.S. provisional patent application 60/651,856 filed Feb. 10, 2005. Both of these applications are hereby incorporated herein by reference in their entirety for all purposes.

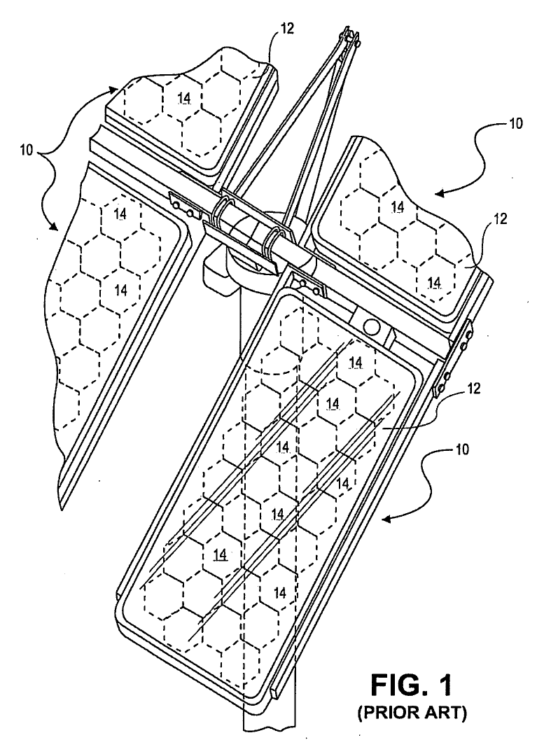

FIG. 1 depicts solar power generating system 10 comprising a plurality of solar panels 12 provided in a substantially planar configuration for concentrating solar energy onto photovoltaic cells (not shown) that convert the solar energy into direct current electricity. The example depicted in FIG. 1 shows four solar panels 12, but it should be appreciated that any number of solar panels may be employed, from a single solar panel to many more than four panels. Each solar panel 12 houses an array of solar concentrating power units 14 that concentrate solar radiation to an optical rod (not shown) mat conducts the solar energy to the photovoltaic cell (not shown). The optical rod is further described in U.S. Patent Publication No. 2006/0207650, entitled “Multi-Junction Solar Cells with an Aplanatic Imaging System and Coupled Non-Imaging Light Concentrator,” which is incorporated herein in its entirety for all purposes. In the exemplary illustration of FIG. 1, thirty-two power units 14 are shown in each solar panel 12, although any number of power units 14 may be used, and such power units may be provided in a variety of configurations, some of which will be discussed in further detail below. These and other particular aspects of the power units will be described in further detail below.

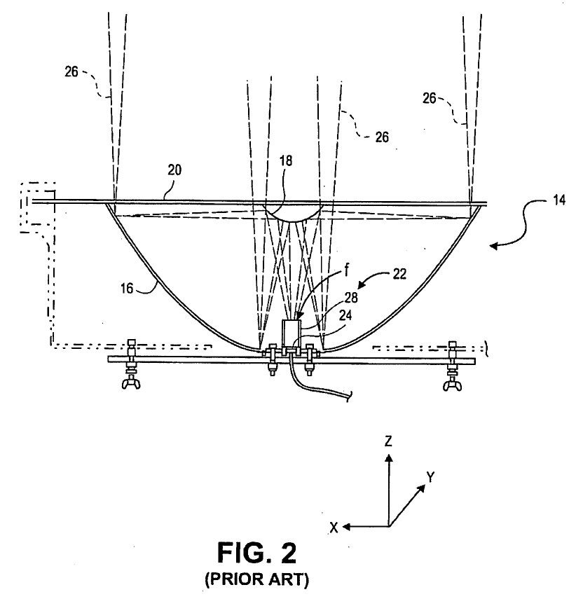

Referring to FIG. 2, select exemplary optical components of each power unit 14 will now be described. The main optical elements of each power unit 14 are primary minor 16, secondary mirror 18, front panel 20, such as a window or cover glazing, and collector assembly 22 defining a nominal focal plane (f). Collector assembly 22 transmits the concentrated solar energy to photovoltaic cell 24. In the preferred embodiment, the shapes of primary mirror 16 and secondary mirror 24 are tailored to capture maximum solar radiation. Front panel 20 is a substantially planar surface, such as a window or other glazed covering, that provides structural integrity for an array of power units and protection for other components thereof.

Solar energy, represented by the dashed-line ray traces 26, enters power unit 14 through substantially planar front panel 20. The concave surface of primary mirror 16 reflects sunlight to the convex surface of secondary mirror 18 that further reflects it to focal plane f. Focal plane f can be generally defined as the central portion or upper surface of optical rod 28 or a point at or beyond the apex of the primary mirror. Optical rod 28 may be tapered in some embodiments away from focal plane f and, in the preferred embodiment, employs substantially total internal reflectance to provide optimal transmission of the solar flux towards photovoltaic solar cell 24. By providing optical rod 28 with a sufficiently wide entrance diameter, the focal point of concentrated sunlight can move around the rod surface with some degree of flexibility, such that solar energy can still be concentrated at a solar cell 24 at the base of optical rod 28. An upper surface defining the entrance for optical rod 28 may also be provided with an antireflective coating to reduce Fresnel reflection losses. The inside and outside surfaces of the front panel, as well as select portions of the optical rod, may be subjected to any type of anti-reflection treatment, such as but not limited to a nano-coating material, to increase optical efficiency over a generally wide solar spectrum.

Primary mirror 16 and secondary mirror 18 are both illustrated as curved components, although it should be appreciated that other shapes may be used. It will also be appreciated that lenses may be used in place of mirrors for concentrating the solar energy. In one embodiment, primary mirror 16 is a second surface mirror using silver, and slump-formed from soda-lime glass. The utilization of silver in primary mirror 16 helps to accommodate a desired spectral response to the ultraviolet levels of light concentrated by power unit 14. The respective perimeters of primary and secondary mirrors 16, 18 may be formed to define a variety of different shapes, although it should be appreciated that in the preferred embodiment, at least a portion of the perimeter of primary mirror 16 and the perimeter of secondary mirror 18 has contact with the surface of front panel 20. The portions of primary mirror 16 and secondary mirror 18 that are in contact with front panel 20 may be physically attached thereto by one of many attachment means, such as but not limited to compression, welding or an adhesive bonding. In some embodiments, primary mirror 18 and secondary mirror 24 may each be radially symmetric about an axis running through the centers of both mirrors and generally perpendicular to front panel 20.

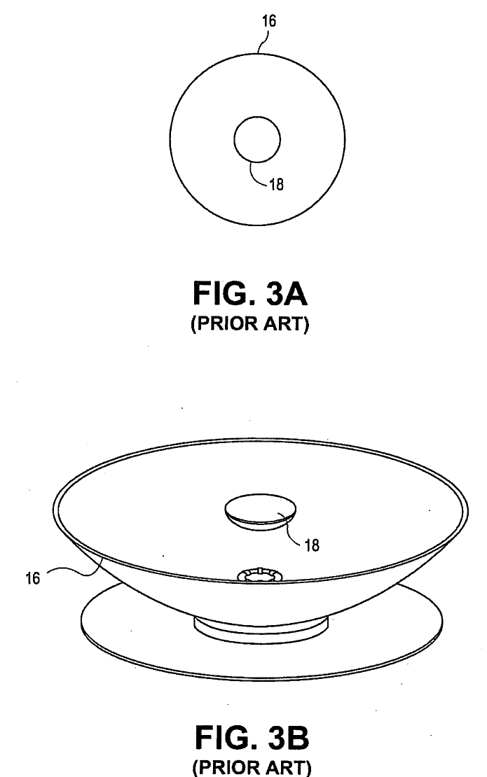

The perimeter of each primary mirror 16 may be formed in a variety of different fashions, and select exemplary embodiments depicting several options will now be presented and discussed with reference to FIGS. 3A-5B. FIGS. 3A-5A illustrate a plan view and FIGS. 3B-5B illustrate a perspective view of the perimeter of primary mirror 16 for three different embodiments of primary mirror 16. FIGS. 3A-B depict an embodiment of primary mirror 16 that has an approximate circular configuration. With a generally circular configuration, the entire perimeter of primary mirror 16 may be substantially coplanar with the perimeter of secondary mirror 18 and perimeters of both may be in contact with, substantially parallel with and/or adhered to the surface of front panel 20.

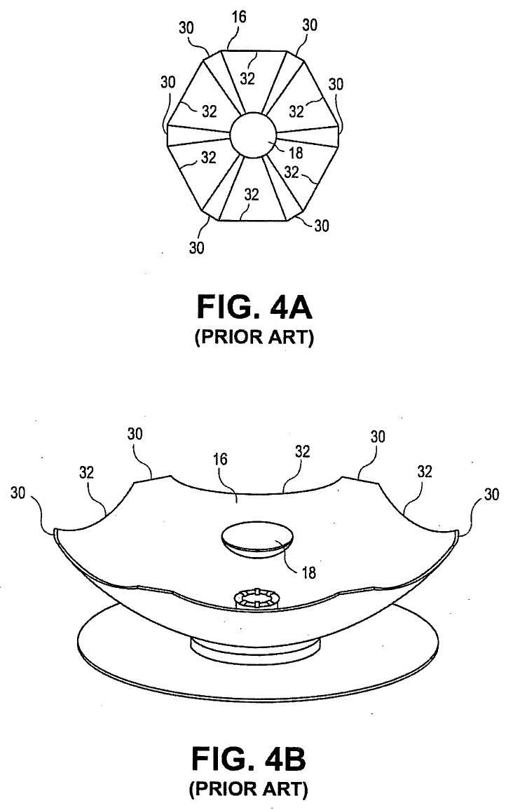

FIGS. 4A-B depict a second embodiment for the shape of primary mirror 16, in which the perimeter of primary mirror 16 is formed in a near-hexagonal fashion. The perimeter of primary mirror 16 is scalloped, defined by six full sections 30 and six truncated sections 32. Full sections 30 are substantially coplanar with one another such that they may be provided in contact with, substantially parallel with and/or adhered to the surface of front panel 20. Each truncated section 32 of the perimeter of primary mirror 16 is formed to define a generally arched segment that extends away from front panel 20. Each truncated section 32 exists in a respective vertical plane that is substantially perpendicular to front panel 20. Truncated sections 32 of each primary mirror 16 may be matched against a truncated section of an adjacent power unit's primary mirror. This matching of adjacent truncated sections 32 can be visualized in the illustration of FIG. 1, where the primary mirror of each power unit 14 is provided adjacent to a portion of at least two other primary mirrors. The scalloped shape of primary mirrors 16 permits an efficient manner in which to pack power units 14 into solar panel 12.

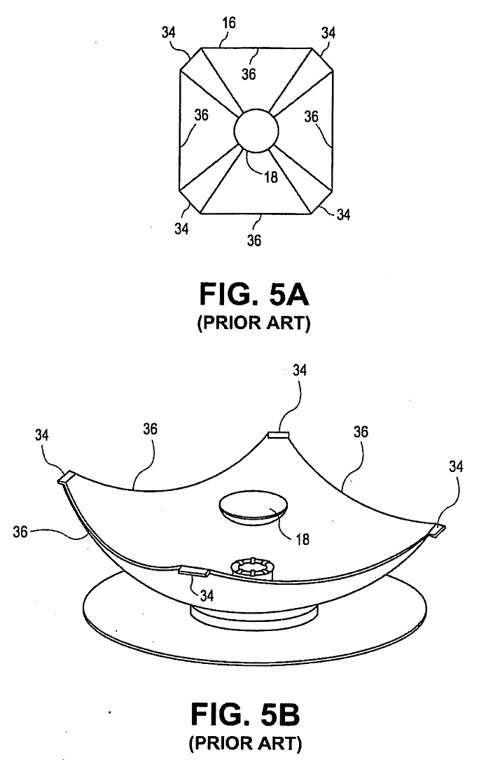

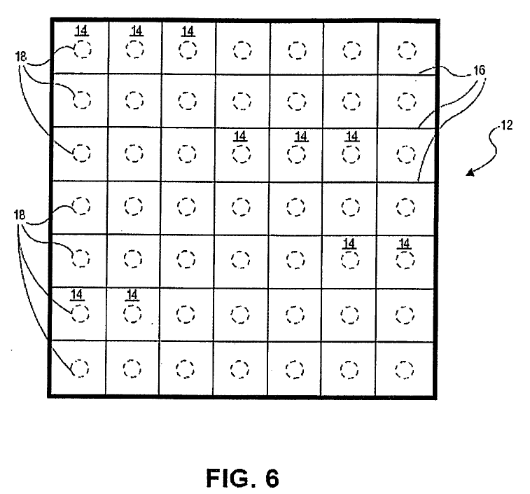

FIGS. 5A and 5B depict a third embodiment of another exemplary shape for primary minor 16, in which the perimeter of primary mirror 16 is formed in an approximate square configuration. The perimeter of primary mirror 16 is defined by four full sections 34, and four truncated sections 36. Full sections 34 are substantially coplanar with one another such that they may be provided in contact with, substantially parallel with, and/or adhered to the surface of front panel 20. Each truncated section 36 of the perimeter of primary mirror 16 is formed to define a generally arched segment that extends away from front panel 20. Each truncated section 36 exists in a respective vertical plane that is substantially perpendicular to front panel 20. Truncated sections 36 of each primary mirror 16 may be matched against a truncated section of an adjacent power unit's primary mirror. Referring to FIG. 6, an array of power units 14 may comprise substantially square perimeter primary mirrors 16 along with secondary mirrors 18.

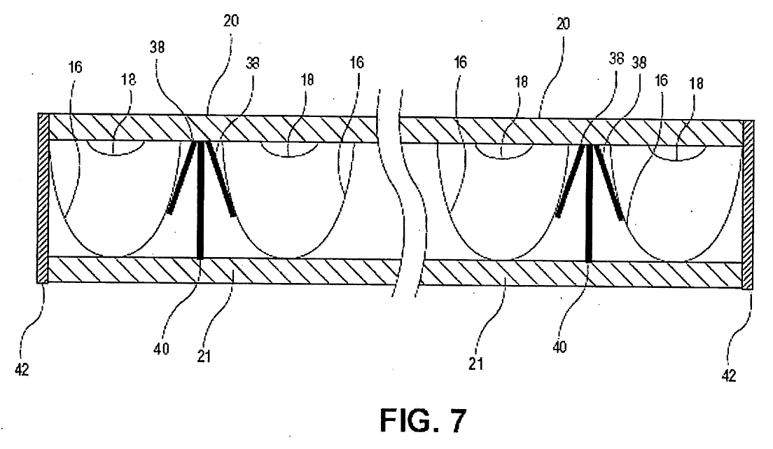

It should be appreciated in some embodiments of the disclosed technology that the respective perimeters (or portions thereof) of the primary and secondary mirrors may not be precisely arranged in a coplanar fashion. Effective operation of a power unit may still be achieved with a slightly staggered arrangement along the coaxial alignment of primary and secondary mirrors within a predetermined tolerance. It will be further appreciated that although FIGS. 3-5 depict three exemplary embodiments for the shape of primary mirror 16, many other options may be employed in accordance with the present invention. For example, the perimeter of primary mirror 16 may be formed as any near-polygonal shape defined by n full sections and n truncated sections, where n is an integer number generally within a range of between three and nine. As with the above examples, each of the full sections in such embodiments are typically in contact with and/or adhered to the inner surface of a front panel. Each truncated section is formed as a circular arc that extends away from the front window and that exists in a respective plane that is substantially perpendicular to the front window. Each truncated section may be in contact with and/or adhered to a truncated section of an adjacent power unit's primary mirror. FIG. 7 depicts a cross-section of a solar panel in accordance with an embodiment of the present invention. This solar panel comprises, generally and without limitation, front panel 20, rear panel 21, primary mirrors 16, secondary mirrors 18, clips 38, and pedestals 40. As noted, FIG. 7 excludes many items, such as a collector assembly, in order to focus on some structural elements of the solar panel. Side walls 42 are provided at the edges of the solar panel to provide, among other things, structural stability to the solar panel. Pedestals 40 are provided as a means to maintain the space between front panel 20 and rear panel 21 and as additional structural support. Clips 38, as explained in further detail below, help secure primary mirrors 16 in a predetermined alignment to facilitate the manufacture of the solar panel. In the preferred embodiment, the boundaries of the structure of the solar panel serve to constrain and align primary mirrors 16 at the boundaries of the solar panel. Alternatively, a half clip could be used to secure the primary mirrors at the boundary.

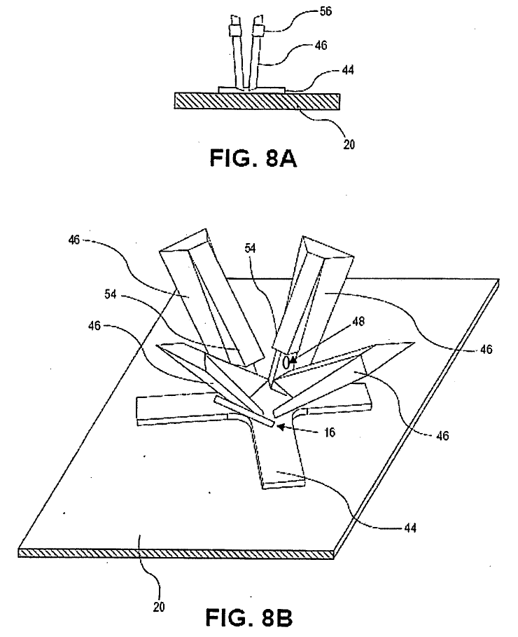

One aspect of the current invention is to facilitate the alignment of primary mirror 16 in the x-y plane of front panel 20 in an array of primary minors to form an array of power units within a solar panel. The skilled artisan will appreciate that facilitating proper alignment of the primary mirrors, within a certain tolerance, will facilitate the manufacturability of the arrays and hence the solar concentrating system. FIG. 8A depicts in profile view and FIG. 8B in perspective view, in accordance with one embodiment of the present invention, clip 38 for aligning and securing the primary mirror in the x-y plane of front panel 20. The clip and other embodiments of the present invention are describe herein with reference to aligning and securing a primary mirror having a square shape in the scalloped configuration described above. It will be appreciated that this and other embodiments of the present invention are not limited to one particular shape of the primary mirror. Clip 38 in FIG. 8A has base section 44 that is secured to front panel 20, where multiple bases 44 are arranged in the x-y plane of front panel 20 such that a desired alignment of the mirrors will be achieved, within certain tolerances. At present, the preferred alignment requirement on the x-y plane is approximately 0.3 to 0.5 mm. Base section 44 is secured to front panel 20, preferably, with tape. Presently, it is preferred to use adhesive tape such (and without limitation) VHB™, which is also the presently preferred attachment mechanism used to secure the secondary mirror to the front pane. However, the skilled artisan will appreciate that other mechanisms and/or materials of securing can be used, such as and without limitation adhesive, for example and without limitation epoxy or silicon.

For the purpose of discussion, and not by way of limitation, each clip will secure four adjacent primary mirrors. Four prongs 46 extend from base 44 in a nonsecuring position, prior to placement of the primary mirror. The non-securing position, as shown in FIG. 8A, is approximately straight up, but the nonsecuring position need only provide sufficient room for placing the primary mirror before moving prongs 46 into the securing position that is demonstrated in FIGS. 8B and 8C. The nonsecuring position permits the placement of primary mirror so as to substantially avoid damaging the primary mirror during placement on the front panel by virtue of it hitting prongs 46.

Referring to FIGS. 8B and 8C, after primary mirror 16 is placed, prong 46 is deformed so as to bias it against primary mirror 16, thereby securing the primary mirror in the approximate desired alignment in the x-y plane of font panel 20. FIG. 8C shows two prongs 46 in the secured position securing two adjacent primary mirrors 16. In the example being used for this discussion, and referring again to FIG. 8B, four prongs 46 are provided to secure four adjacent primary mirrors. As discussed, the structure of the solar panel will secure and align the primary mirrors at the boundaries of the solar panel.

Returning to FIG. 8C, pedestal 40 may be placed to spread prongs 46 into the securing position after primary mirrors 16 have been placed, or prongs 46 may be put into the secured position before pedestal 40 is put in place. Additionally, adhesive 47 may be applied to the clip, which will flow through holes 48 (see FIG. 8B) provided in prongs 46 and adhere to the external surface of primary mirror 16. Adhesive 47 may be placed before or after prongs 46 are deformed into the securing position. Adhesive 47 will also aid in securing pedestal 40. Prongs 46 may have wedge shaped piece 50 that contacts and aids in securing primary mirror 16 when prongs 46 are deformed into the securing position.

Referring to FIG. 8D, prongs 46 may also have wedge shaped locks 52 facing towards pedestal 40. Pedestal 40 has a groove or detent 54 that engages wedge shaped locks 52 in order to aid locking the pedestal in place and maintaining the prongs in the securing position. Materials for prongs 46 can include (by way of example and without limitation) metal, plastic or other suitable polymeric material for non permanently deformable prongs, and metal is preferred for permanently deformable prongs. The locking mechanism can also be similar to a “latching” mechanism which locks the position of the clip in a certain shape.]

FIG. 8E demonstrates a further embodiment for securing the primary mirror. In this further embodiment, base 44 comprises threaded nut 44A, and base 44 has no prongs, as in the previously described embodiment. Pedestal 40 has threaded end 40A that threads into threaded nut 44A. Pedestal 40 goes through wedge shaped structure 51. A four sided example of wedge shaped structure 51 is shown securing primary mirrors with a substantially square perimeter; however, it will be appreciated that other shapes may be use as dictated by the perimeters of the primary mirrors. Wedge shaped structure 51 is fitted on pedestal 40 such that pedestal 40 can substantially freely rotate without turning wedge shaped structure 51, and such that wedge shaped structure 51 does not move substantially up or down pedestal 40. In this embodiment, base 44 (with nut 44A) is secured to front panel 20 in the approximate desired alignment of primary mirrors. As the mirrors are placed, pedestal 40 (with threaded end 40A) is threaded into nut 44A. Threading of pedestal 40 causes wedge shaped structure 51 to move downward and abut adjacent primary mirrors, thereby securing them in place. As will be appreciated wedge shaped structure 51 serves essentially the same purpose in securing the primary mirrors as do prongs 46. Additionally, adhesive 53 can be applied between primary mirrors 16 and wedge shaped structure 51 to secure the primary mirrors, the pedestal, and the wedge shaped structure.

It will be appreciated that nut 44A and threaded end 40A is only one exemplary way to mate the two pieces together. Alternatively, a press fit or adhesive mechanism or any combination can be used. For example, the end of pedestal 40 could be press fit into nut 44A, in which case neither would have threads. Additionally, a press fit may not be necessary, but rather adhesive could be applied to the end of pedestal 40 and inserted into a hole (not shown) in base 44, or a combination of press fitting and adhesive may be used. The end result will be to advance or press wedge shaped structure 51 down and abutting against primary mirrors 16 to secure them in place. If using one of these alternative mechanisms, then it would not be necessary to mount wedge shaped structure 51 to pedestal 40 in a manner described above. Rather, wedge shaped structure 51 could be fixedly attached to pedestal 40. In a further alternative, also described in more detail below, wedge shaped structure 51 could be attached to the top of a rod (not shown) and the rod could be press fit or otherwise attached to base 44 as described. A hole (not shown) can be placed through wedge shaped structure 51 and the rod (not shown) through winch pedestal 40 could be placed to serve as a spacer between the front and back panels of the solar concentrating array.

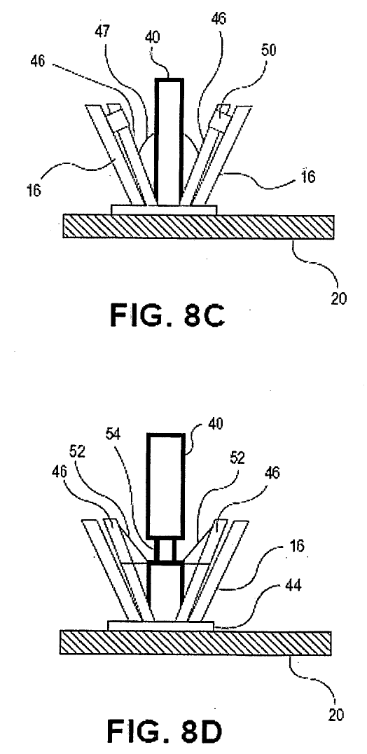

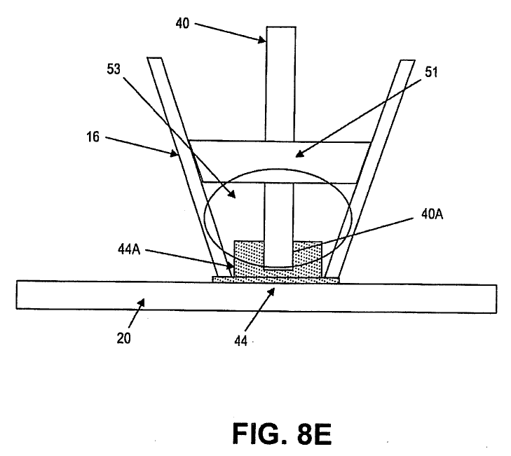

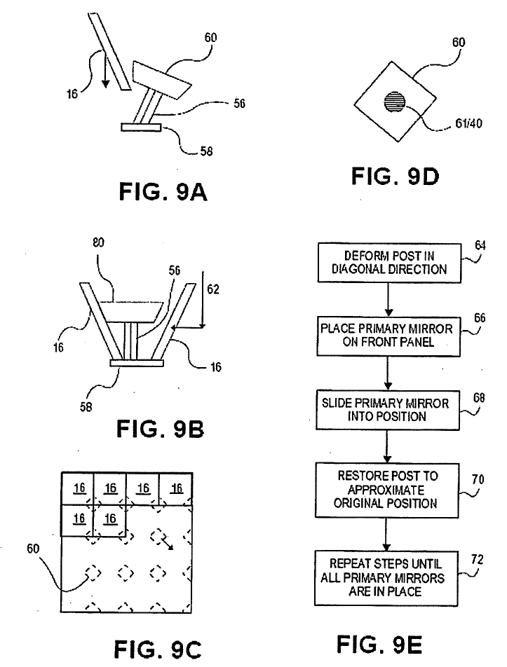

FIGS. 9A-B depicts an alternative embodiment of a clip. This clip has prong or post 56 extending from base 58. Partial pyramidal member 60 sits upside down on top of post 56. Post 56 can be deformed and returned to its approximate original position, or, alternatively, it can return to its approximate original position on its own by virtue of the material from which it is made, or a combination of both. It is preferred to have flexibility in one direction and rigidity in the normal direction without substantial plastic deformation. Polymers and high yield metals (e.g., steel) provide such properties, and are listed by way of example and not limitation. Alternatively, post 56 can be rigid, as described above, and press fit to base 58. In this embodiment, post 56 is deformed in one direction, thereby moving partial pyramidal member 60 such that primary mirror 16 can be positioned in the solar panel. Post 56 Is then returned to its approximate original position (shown in FIG. 9B), and partial pyramidal member 60 biases against primary mirror 16 to secure it in die approximate desired orientation inside the solar panel.

Referring to FIG. 9C-D, the alternative clip has a preferred order when placing primary mirrors 16 on a front panel FIG. 9C depicts a front panel onto which an array of primary mirrors 16 are placed for constructing a solar panel. Clip member 60 placement is illustrated with respect to location adjacent primary mirrors 16 within the solar panel. Now referring to FIG. 9D, hole 61 is optionally provided through post 56 and through member 60 into which pedestal 40 may be placed. As described above, pedestal 40 provides a means by which to space the front and back panels and by which to provide additional structural support.

FIG. 9E illustrates a method for installing the primary mirrors on the front panel. At step 64, post 56 is deformed in a diagonal direction. In the example depicted in FIG. 9C, deformation is approximately 45 degrees down as shown by arrow 62. At step 66, primary mirror 16 is placed on front panel 20 and at step 68, primary mirror 16 is moved into position. In the example shown in FIG. 9C, primary mirror 16 is moved to the left and up. At step 70, post 56 is restored to its approximate original position, thereby biasing partial pyramidal member 60 against primary mirror 16 and securing it in the approximately desired orientation. It will be appreciated, that deforming post 56 provides sufficient room to place primary mirror 16 on front panel 20, after which the mirror is moved in the left direction and up direction to abut the primary mirror being installed against the other partial pyramidal members 60 that secure adjacent primary mirrors. The post that was deformed is then returned to its approximate original position, thereby biasing the partial pyramidal member against the primary mirror most recently placed. At step 72, the process repeats itself until all of the primary mirrors are installed. As described above, the edges of the solar panel structure will provide securing support to the primary mirrors at the boundaries of the array. When installing the last row of mirrors tilting of the mirrors might be required in order to successfully place the mirror if no clearance is provided. Additionally, the last row of mirrors will require a different post shape at the edge of the last row. The post will bend along the edge. The corner mirror locking will require a different mechanism to prevent horizontal displacement. A removable clip attached to the wall can provide such a locking mechanism to serve this purpose. Alternatively, post 56 could be press fit into the base, as described above, thereby advancing pyramidal member 60 against the outer most primary mirrors to secure them in place.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention. Thus, it is intended that the present subject matter covers such modifications and variations as come within the scope of the appended claims and their equivalents.

What is claimed is:

1. A system for securing and aligning optical components in a solar concentrating array of said optical components, said system comprising:
a front panel; and
a plurality of clips having a base and a securing member extending upwards from said base in a non-securing position, wherein said base of each clip is secured to one face of said front panel in a predetermined pattern to achieve a desired alignment of said optical components, wherein said securing members is deformable from said non-securing position into a securing position, and wherein in said securing position said securing member abuts against an optical component within said array, thereby securing said optical component in said solar concentrating array in approximate accordance with said desired alignment of said optical components.

2. The system for securing and aligning optical components according to claim 1, wherein said securing member is at least two prongs.

3. The system for securing and aligning optical components according to claim 2 further comprising:
a pedestal between said at least two prongs to maintain said at least two prongs in said securing position.

4. The system for securing and aligning optical components according to claim 2 further comprising:
a wedge shaped structure on each prong, wherein said wedge shaped structure abuts against adjacent optical components within said array.

5. The system for securing and aligning optical components according to claim 2 further comprising:
a wedge shaped structure located on each prong, wherein said wedge shaped structure abuts against adjacent optical components within said array; and
a pedestal between said at least two prongs to maintain said at least two prongs in said securing position, wherein said wedge shaped structures engage a notch on said pedestal, thereby locking said pedestal into place.

6. The system for securing and aligning optical components according to claim 2, wherein said optical components have a parabolic cross section.

7. The system for securing and aligning optical components according to claim 6, wherein said optical components are curved.

8. The system for securing and aligning optical components according to claim 7, wherein said optical components have a substantially rectilinear perimeter.

9. The system for securing and aligning optical components according to claim 2, wherein said clips are comprised aluminum, steel or flexible polymer.

10. The system for securing and aligning optical components according to claim 2, wherein said prongs are permanently deformable.

11. A system for securing and aligning optical components In a solar concentrating array of said optical components, said system comprising:
a front panel; and
a plurality of securing members having a base and a rod extending from said base and a beveled member mounted on said rod, wherein said base of each securing member is attached to one face of said front panel in a predetermined pattern to achieve a desired alignment of said optical components, and wherein said beveled member abuts against adjacent optical components within said array, thereby securing said optical components in said solar concentrating array in approximate accordance with said desired alignment of said optical components.

12. The system for securing and aligning optical components according to claim 11, wherein said rod is resiliency deformable and said beveled member is mounted on top of said rod.

13. The system for securing and aligning optical components according to claim 12, wherein said rod and said beveled member have a hole therethrough for placement of a pedestal, wherein said pedestal serves as a spacer between said front panel and a back panel in said solar concentrating array.

14. The system for securing and aligning optical components according to claim 11, wherein said rod is detachably fit to said base.

15. The system for securing and aligning optical components according to claim 14, wherein said rod is threadably detachable to said base such that threading said rod to said base abuts said beveled member against said optical components.

16. The system for securing and aligning optical components according to claim 14, wherein said rod is threadably detachable to said base, and wherein said beveled member is mounted on said rod such that rotation of said rod does not substantially rotate said beveled member, and such that said beveled member does not substantially move up or down said shaft, whereby threading of said rod to said base results in said beveled member abutting against and securing said optical components in substantially said desired alignment.

17. The system for securing and aligning optical components according to claim 16, wherein said base has a threaded nut into which said rod is threadably attached to said base.

18. A method for securing and aligning an array of optical components in a solar concentrating panel, said method comprising the steps:
a. adhering a base having a plurality of securing members extending therefrom to a front panel in a predetermined pattern to achieve a desired alignment of said optical components, wherein said securing member is initially in a non-securing position;
b. placing said optical component within said panel; and
c. deforming said securing member from said non-securing position into a securing position, wherein in said securing position said security member abuts against adjacent optical components within said panel, thereby securing said optical components in said solar concentrating array in approximate accordance with said desired alignment of said optical components.

19. The method for securing and aligning an array of optical components according to claim 18 further comprising the step of placing attachment material between said securing member and said optical components.

20. The method for securing and aligning an array of optical components according to claim 18, wherein said deforming step comprises inserting a pedestal in said securing member.

21. The method for securing and aligning of optical components according to claim 18,
wherein said securing member further comprises a deformable rod, a base and a beveled member; and
wherein said deformable rod extends from said base and said beveled member is on top so said deformable rod.

22. The method for securing and aligning of optical components according to claim 19, wherein said beveled member abuts against said optical component in said securing position, thereby securing and aligning said optical component within said panel.

23. The method for securing and aligning of optical components according to claim 18, wherein said securing member further comprises at least two prongs.

24. The method for securing and aligning of optical components according to claim 23, further comprising the step of placing attachment material between said prongs and said optical components.
